(19) United States
(12) Patent Application Publication
(10) Pub. No.: US 2002/0106079 A1
(43) Pub. Date: Aug. 8, 2002

(54) Method and apparatus for altering the strength of an encryption system

(76) Inventors: Anthony Patrick Mauro, San Diego, CA (US); Magdalena Leuca Espelien, San Diego, CA (US)

Correspondence Address: QUALCOMM Incorporated, Attn: Patent Department, 5775 Morehouse Drive, San Diego, CA, 92121-1714, US

(21) Appl. No.: 10/029,485

(22) Filed: Dec. 19, 2001

Related U.S. Application Data
(60) Provisional application No. 60/257,200, filed on Dec. 19, 2000.

(51) Int. Cl. H04L 9/00

(52) U.S. Cl. 380/29

(57) ABSTRACT

A method and apparatus for altering a strength of an encryption system contained within an electronic device, such as a wireless communication device. A cryptographic key is stored in a memory of the electronic device. A first cipher processor encrypts unencrypted data using the cryptographic key to generate encrypted data, which is provided to a second cipher processor. The second cipher processor decrypts the encrypted data using the cryptographic key to generate the original unencrypted data, which is then provided to a third cipher processor. The third cipher processor encrypts the unencrypted data using the cryptographic key to generate encrypted data.

### CROSS REFERENCE TO RELATED APPLICATION

This application claims the benefit of U.S. Provisional Patent Application Serial No. 60/257,200, filed Dec. 19, 2000, which is incorporated herein by reference in its entirety.

### BACKGROUND

I. Field of the Invention

The present invention pertains generally to the field of cryptography, and more specifically to a method and apparatus for altering the strength of an encryption system.

II. Description of the Related Art

Cryptographic ciphers are often measured and described in terms of their strength. Different ciphers offer different strength depending on how hard they are to break. “Strong” ciphers are more difficult to break than “weak” ciphers. Different types of data lend themselves to different strengths of cryptography. For instance, if the cost required to break a cipher is greater than the value of the protected data, that particular cipher is most likely appropriate for the data even though the cipher may be relatively weak compared to other ciphers. If the time required to break a cipher is longer than the time needed to keep the protected data secret, the cipher is properly suited for the data.

In many types of cryptography, the cipher typically derives its strength from the length of the key used to encode the data. A “key” is a string of bits and its “length” is expressed in the number of bits in the string. The same cipher can be weak or strong depending upon the key length. A cipher with a comparatively short key length (e.g., 40 or 56 bits) may be considered weak, whereas the same cipher with a comparatively long key length (e.g., 128 bits) may be deemed strong. It is common today for various software products to employ ciphers with 40-bit or 56-bit keys, which are generally characterized as weak, as well as ciphers that employ 128-bit keys, which are generally considered to be strong.

Because of their potential for illegal or improper use, cryptographic ciphers cannot be exported from the United States without approval from the U.S. government. Generally, products with “weak” ciphers having short key length may be exported. Such products are said to have “exportable strength” cryptographic functionality. Products with “strong” ciphers having long key lengths are usually not permitted to leave the country. To export a cryptographic product from the U.S., the product manufacturer or exporter must first obtain an export license from the U.S. government.

As a result of this government policy, the makers of cryptographically enhanced products face a dilemma. They would like to make a single product that can be sold in the U.S. and exported abroad without the hassle of securing special export licenses for each and every foreign market.

In practice, products such as computers, mobile telephones, and so on are loaded with software that provides various cryptographic functions, such as data encryption, decryption, digital signing, and authentication. To enable global exportation to foreign countries without having to secure special export licenses, the manufacturer of such products typically configures the products with a weak “exportable-strength” cipher. As a result, the U.S. version of the product is likewise pared down to the lowest exportable-strength cipher. However, some U.S. customers might request and be entitled to use higher strength ciphers. Such customers must submit special requests to the provider, along with proof of residence and proposed use, before the manufacturer can release a stronger version of the product.

Accordingly, when a U.S. customer is granted a stronger version, the “weak” software is completely replaced by the requested “strong” version. It is often inconvenient for the user to wait while the strong version is loaded into the desired device. As a result, there is a need to provide an improved technique for altering the strength of such cryptographically enhanced products.

### SUMMARY

The present invention is directed to a method and apparatus for altering the strength of an encryption system. In one embodiment, a wireless communication device comprises an apparatus for altering a strength of an encryption system contained therein, comprising a memory for storing a cryptographic key and a first cipher processor for receiving unencrypted data and for generating encrypted data using the cryptographic key. The encrypted data is then providing to a second cipher processor, the second cipher processor for decrypting the encrypted data using the cryptographic key to generate the original unencrypted data. The unencrypted data is then provided to a third cipher processor, the third cipher processor for encrypting the unencrypted data using the cryptographic key to generate encrypted data.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates an electronic device 100 employing an apparatus for altering a strength of an encryption system; and

FIG. 2 is a flow diagram illustrating one embodiment of a method for altering a strength of an encryption system.

### DETAILED DESCRIPTION

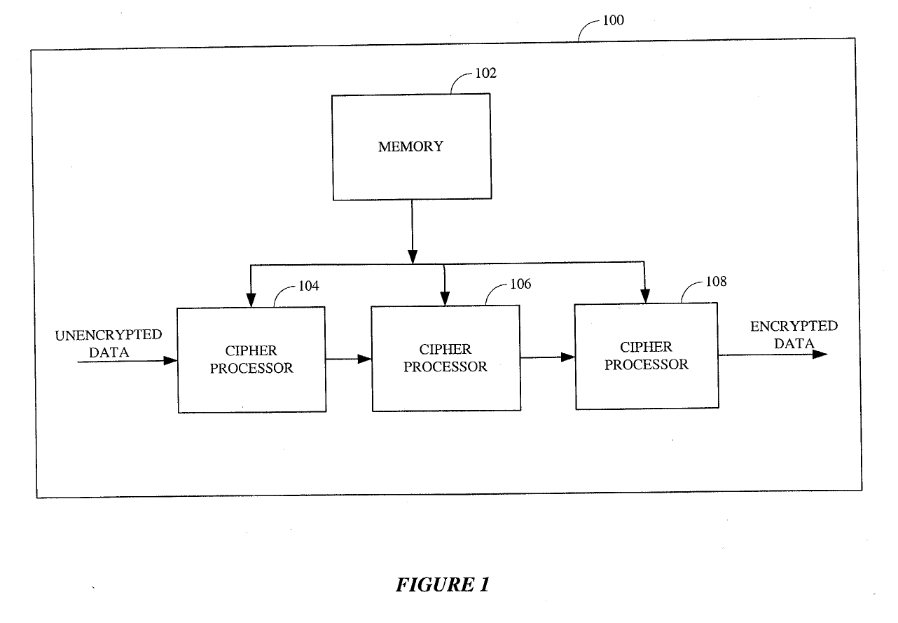

FIG. 1 illustrates an electronic device 100 employing an apparatus for altering a strength of an encryption system. Electronic device 100 comprises one of a variety of electronic devices commonly used in the world today, such as a wireless or wireline telephone, a wireless or wireline modem, a data terminal, a pager, a Personal Digital Assistant (PDA) etc. Each of these devices may have a need to transmit or receive “secure” information, or information that has been encrypted using one of a variety of encryption techniques. Although electronic device 100 is discussed herein as comprising a wireless communication device (such as a cellular telephone), it should be understood that the teachings of the method and apparatus for altering a strength of an encryption system could be applied to any of the electronic devices mentioned above, without limitation.

Electronic device 100 comprises a memory 102 and three cipher processors shown as cipher processor 104, 106, and 108. Other functional elements have been omitted from FIG. 1 for clarity.

Memory 102 comprises an electronic digital memory, generally for storing executable computer instructions and related data. Memory 102 may comprise a random access memory (RAM), a read-only memory (ROM), flash memory, electrically-erasable programmable read-only memory (EEPROM), ultra-violet programmable read-only memory (UVPROM), or any other electronic memory known in the art. Memory 102 could alternatively comprise an electro-mechanical storage device such as a hard drive, a tape drive, a CD rom, or others.

Memory 102 stores cryptographic “keys” that comprise a sequence of random digits, or bits, and are used with a cipher algorithm to encrypt and decrypt information that is transmitted or received by electronic device 100. In one embodiment, a number of keys are stored within memory 102.

The arrangement of three cipher processors to encrypt information is well known in the art. In one embodiment, the three cipher processors shown in FIG. 1 comprise an encryption scheme known as “Triple DES”. DES (Data Encryption Standard) is a well known encryption scheme which uses an encryption key and a cipher algorithm to encrypt and decrypt information. Triple DES, in effect, simply encrypts and decrypts information three times.

The “strength”, of any cipher algorithm depends largely on the length, or number of digits, of the encryption key that is used to encrypt information. A key length of 56 bits is considered to be a “weak” key while a key length of 128 bits is considered to be a “strong” key. Triple DES typically uses three keys to provide encryption. If each key is 56 bits in length, then the effective key length is 168 bits, resulting in a much stronger encryption strength.

Electronic device 100 is able to provide for such strong encryption by using three different keys, all stored in memory 102, each key used in each of the cipher processors, respectively. As shown in FIG. 1, unencrypted information, such as digitized voice or data, is provided to cipher processor 104. Cipher processor 104 uses a first key stored in memory 102 to encrypt the unencrypted information to generate encrypted information that is provided to cipher processor 106. Cipher processor 106 receives the encrypted information and encrypts it again using a second key that is stored in memory 102. Finally, the twice-encrypted information is provided to cipher processor 108, where it is encrypted a third time using a third key stored in memory 102. The resultant thrice-encrypted information is then provided to another functional block of electronic device 100 for further processing.

Each of the cipher processors shown in FIG. 1 encrypts data using a cipher algorithm, which is a mathematical process used to encrypt and decrypt information. Each of the cipher processors shown in FIG. 1 comprise executable computer instructions which define a particular cipher algorithm. The three cipher processors generally all use the same cipher algorithm.

It is well known that the same cipher algorithm can both encrypt and decrypt information if the cipher algorithm comprises a Feistel structure, which is well known in the art. For example, if information is encrypted by a DES cipher processor using a first key, the encrypted information can be decrypted by providing the encrypted information to the cipher processor and processing the encrypted information using the first key that was used during the encryption process.

In certain circumstances, it would be desirable to provide both strong encryption and weaker encryption in electronic device 100. Generally, the triple-encryption technique shown in FIG. 1 cannot be altered and, therefore, a separate circuit or software must be added to electronic device 100 if weaker encryption is desired. The present invention is directed to avoiding the need to provide additional hardware or software to electronic device 100 to provide weaker encryption.

To provide weaker encryption, a single cryptographic key is used for all three ciphers shown in FIG. 1. Unencrypted information is provided to cipher processor 104. Cipher processor 104 uses a first key stored in memory 102 to encrypt the unencrypted information to generate encrypted information that is provided to cipher processor 106. The key length could be 54 bits in length, resulting in relatively “weak” encryption. Cipher processor 106 receives the encrypted information and this time decrypts it, using the same cryptographic key that was used to encrypt the information in cipher processor 104. The result from cipher processor 106 is the original, unencrypted information. The unencrypted information from cipher processor 106 is then is provided to cipher processor 108, where it is encrypted a using the same key that was used in cipher processors 104 and 106. The result from cipher processor 108 is relatively weak encrypted information from using a relatively short key length (much less than the effective key length of triple-DES). In another embodiment, a second key is used by cipher processor 108 to encrypt the information.

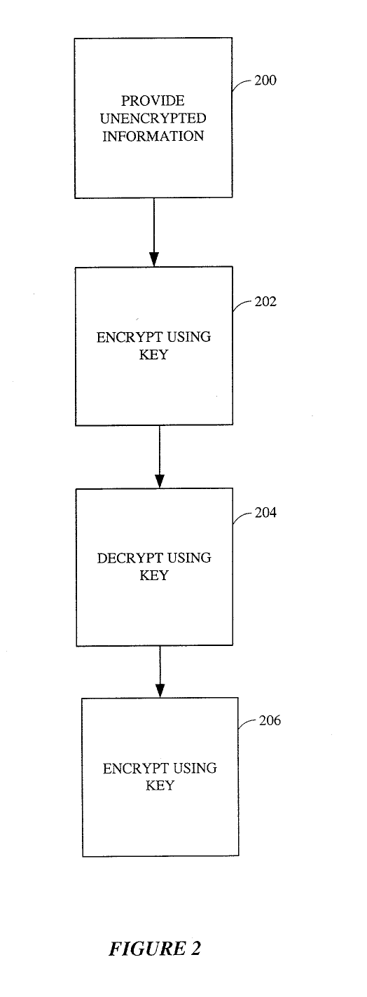

FIG. 2 is a flow diagram illustrating one embodiment of a method for altering a strength of an encryption system. In step 200, unencrypted data is provided to cipher processor 104. In step 202, cipher processor 104 uses a cryptographic key and a cipher algorithm to encrypt the unencrypted information to generate encrypted information. The encrypted information is then provided to cipher processor 106.

In step 204, cipher processor 106 decrypts the encrypted information, using the same cryptographic key that was used to encrypt the information in step 202. The result from cipher processor 106 is the original, unencrypted information. The unencrypted information from cipher processor 106 is then is provided to cipher processor 108.

In step 206, cipher processor 108 encrypts the unencrypted information using the same key that was used in steps 202 and 204. The result from cipher processor 108 is relatively weak encrypted information from using a relatively short key length (one-third the effective key length of triple-DES). In another embodiment, a second key is used by cipher processor 108 to encrypt the information.

The previous description of the preferred embodiments is provided to enable any person skilled in the art to make and use the present invention. The various modifications to these embodiments will be readily apparent to those skilled in the art, and the generic principles defined herein may be applied to other embodiments without the use of the inventive faculty. Thus, the present invention is not intended to be limited to the embodiments discussed herein, but is to be accorded the widest scope consistent with the principles and novel features disclosed herein.

I claim:

1. A wireless communication device comprising an apparatus for altering a strength of an encryption system contained therein, comprising:
a memory for storing a cryptographic key;
a first cipher processor for receiving unencrypted data and for generating encrypted data using said cryptographic key and providing said encrypted data to a second cipher processor;
said second cipher processor for decrypting said encrypted data using said cryptographic key to generate said unencrypted data and providing said unencrypted data to a third cipher processor; and
said third cipher processor for encrypting said unencrypted data using said cryptographic key to generate said encrypted data.
